(19) United States
(12) Patent Application Publication
(10) Pub. No.: US 2010/0013863 A1
(43) Pub. Date: Jan. 21, 2010

(54) Method and apparatus for facilitating movement within a three dimensional graphical user interface

(76) Inventor: Ciaran Harris, Dublin (IE)

Correspondence Address: HARRINGTON & SMITH, PC, 4 RESEARCH DRIVE, Suite 202, SHELTON, CT, 06484-6212, US

(21) Appl. No.: 12/311,552

(22) PCT Filed: Oct. 27, 2006
(86) PCT No.: PCT/IB2006/003653

§ 371 Date: Oct. 1, 2009

(51) Int. Cl. G09G 5/00

(52) U.S. Cl. 345/679; 345/173; 345/168

(57) ABSTRACT

An apparatus including: an integral display for displaying a graphical user interface having three orthogonal dimensions; an integral first user input device, operable by a user to move within the graphical user interface in a first dimension and a second dimension, orthogonal to the first dimension, when the first user input device is in a first mode, and to move within the graphical user interface in a third dimension, orthogonal to the first dimension and to the second dimension, when the first user input device is in a second mode; and an integral second user input device, operable by a user to change the mode of the first user input device between the first mode and the second mode.

### FIELD OF THE INVENTION

Embodiments of the present invention relate to apparatus. In particular, they relate to portable apparatus for facilitating movement within a three dimensional graphical user interface.

### BACKGROUND TO THE INVENTION

Three dimensional graphical user interfaces are becoming increasingly popular for navigating user selectable objects such as menu structures and files. In a three dimensional graphical user interface, the user may move in three orthogonal dimensions in order to select files and/or folders. On a personal computer, a user may connect peripherals such as a computer mouse or a joystick to facilitate three dimensional control.

However, graphical user interfaces on some apparatus (such as a portable apparatus, an arcade game console or an Automated Teller Machine (ATM)) are usually two dimensional because it is often undesirable to connect the above peripherals to the apparatus. This is because they may increase the overall size of the apparatus and make it awkward to handle or may be vulnerable to theft or vandalism.

Consequently, it would be desirable to provide an alternative apparatus for facilitating movement within a three dimensional graphical user interface.

### BRIEF DESCRIPTION OF THE INVENTION

According to one embodiment of the invention there is provided an apparatus comprising: an integral display for displaying a graphical user interface having three orthogonal dimensions; an integral first user input device, operable by a user to move within the graphical user interface in a first dimension and a second dimension, orthogonal to the first dimension, when the first user input device is in a first mode, and to move within the graphical user interface in a third dimension, orthogonal to the first dimension and to the second dimension, when the first user input device is in a second mode; and an integral second user input device, operable by a user to change the mode of the first user input device between the first mode and the second mode.

The integral first user input device may be operable to move the user's field of view within the graphical user interface. The user's field of view may be moved by changing the position and/or orientation of the user's field of view within the graphical user interface.

The first user input device may be provided on a front surface of the apparatus. The second user input device may be provided on a rear surface of the apparatus.

The second user input device may include a first sensor for changing the mode of the first user input device to the first mode. The second user input device may include a second sensor for changing the mode of the first user input device to the second mode.

The first user input device may be operable by a user to rotate within the graphical user interface, when the first user input device is in a third mode. The second user input device may be operable by a user to change the mode of the first user input device between the first mode, the second mode and the third mode.

The second user input device may include a third sensor for changing the mode of the first user input device to the third mode.

Moving within the first dimension may correspond to horizontal panning in the graphical user interface. Moving within the second dimension may correspond to vertical panning in the graphical user interface. Moving within the third dimension may correspond to dollying within the graphical user interface.

The first user input device may include a keypad of the apparatus.

The first user input device may be incorporated into the display to provide a touch screen display.

According to another embodiment of the invention there is provided a method comprising: displaying a graphical user interface having three orthogonal dimensions on an integral display of an apparatus; changing between a first mode and a second mode of a first user input device, integral to the apparatus, using a second user input device, integral to the apparatus, wherein when in the first mode, movement is enabled within the graphical user interface in a first dimension and a second dimension, orthogonal to the first dimension, and when in the second mode, movement is enabled within the graphical user interface in a third dimension, orthogonal to the first dimension and to the second dimension.

The method may comprise changing between the first mode, the second mode and a third mode of the first user input device, wherein when in the third mode, rotation is enabled in the graphical user interface.

The method may comprise controlling the movement within the graphical user interface via a first user input device of the apparatus. The first user input device may be provided on a front surface of the apparatus.

The second user input device may be provided on a rear surface of the apparatus.

Moving within the first dimension may correspond to horizontal panning in the graphical user interface. Moving within the second dimension may correspond to vertical panning in the graphical user interface. Moving within the third dimension may correspond to dollying within the graphical user interface.

According to a further embodiment of the invention there is provided a computer program comprising program instructions for causing a computer to perform the method as described in the preceding paragraphs.

According to another embodiment of the invention there is provided a computer program comprising program instructions for enabling movement within a graphical user interface, of an apparatus, having three orthogonal dimensions and comprising means for changing between a first mode and a second mode of a first user input device, integral to the apparatus, using a second user input device, integral to the apparatus, wherein when in the first mode, movement is enabled within the graphical user interface in a first dimension and a second dimension, orthogonal to the first dimension, and when in the second mode, movement is enabled within the graphical user interface in a third dimension, orthogonal to the first dimension and to the second dimension.

According to a further embodiment of the present invention, there is provided a physical entity embodying the computer program as described in the preceding paragraphs.

According to another embodiment of the present invention, there is provided an electromagnetic carrier signal carrying the computer program as described in the preceding paragraphs.

According to a further embodiment of the present invention, there is provided a graphical user interface, for an apparatus, having three orthogonal dimensions and operable in a first mode and a second mode of a first user input device, integral to the apparatus, wherein when in the first mode, movement is enabled within the graphical user interface in a first dimension and a second dimension, orthogonal to the first dimension, and when in the second mode, movement is enabled within the graphical user interface in a third dimension, orthogonal to the first dimension and to the second dimension.

According to another embodiment of the invention there is provided an apparatus comprising: means, integral to the apparatus, for displaying a graphical user interface having three orthogonal dimensions; means, integral to the apparatus, for providing movement within the graphical user interface in a first dimension and a second dimension, orthogonal to the first dimension, when the first user input device is in a first mode, and for providing movement within the graphical user interface in a third dimension, orthogonal to the first dimension and to the second dimension, when the first user input device is in a second mode; and means, integral to the apparatus, for changing the mode of the first user input device between the first mode and the second mode.

### BRIEF DESCRIPTION OF THE DRAWINGS

For a better understanding of the present invention reference will now be made by way of example only to the accompanying drawings in which:

FIG. 1 illustrates a schematic diagram of one embodiment of an apparatus;

FIG. 2 illustrates a diagram showing horizontal and vertical panning within a three dimensional graphical user interface;

FIG. 3 illustrates a diagram showing dollying within a three dimensional graphical user interface;

FIG. 4 illustrates a diagram showing rotation within a three dimensional graphical user interface;

FIG. 5A illustrates a diagram of a front surface of one embodiment of an apparatus;

FIG. 5B illustrates a diagram of a rear surface of the apparatus illustrated in FIG. 5A;

FIG. 6A illustrates a diagram of a front surface of another embodiment of an apparatus;

FIG. 6B illustrates a diagram of a rear surface of the apparatus illustrated in FIG. 6A; and

FIG. 7 illustrates a flow diagram according to one embodiment of the present invention.

### DETAILED DESCRIPTION OF EMBODIMENTS OF THE INVENTION

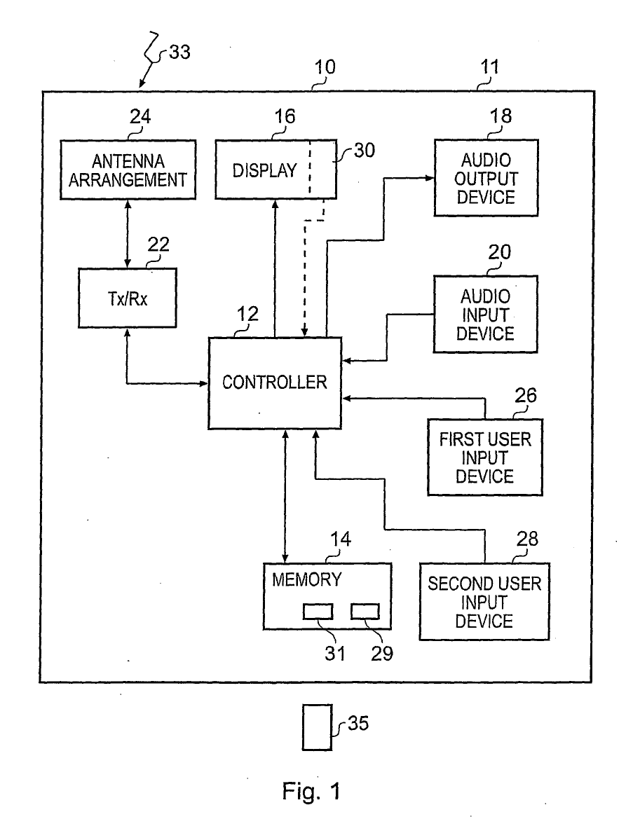

FIGS. 1, 5A, 5B, 6A and 6B illustrate an apparatus 10 comprising: an integral display 16 for displaying a graphical user interface having three orthogonal dimensions; an integral first user input device 26, operable by a user to move within the graphical user interface in a first dimension and a second dimension, orthogonal to the first dimension, when the first user input device 26 is in a first mode, and to move within the graphical user interface in a third dimension, orthogonal to the first dimension and to the second dimension, when the first user input device 26 is in a second mode; and an integral second user input device 28, operable by a user to change the mode of the first user input device 26 between the first mode and the second mode.

FIG. 1 illustrates a schematic diagram of one embodiment of an apparatus 10. In more detail, the apparatus 10 includes a housing 11 which houses a controller 12, a memory 14, a display 16, an audio output device 18, an audio input device 20, a transceiver 22, an antenna arrangement 24, a first user input device 26 and a second user input device 28. It should be appreciated that the display 16, the first user input device 26 and the second user input device are integral to the apparatus 10, i.e. they are all housed within the housing 11.

The apparatus 10 may be any electronic device which includes an integral display and an integral user input device. For example, the apparatus 10 may be a portable apparatus, an arcade game console or an Automated Teller Machine (ATM). A portable apparatus is any electronic device which can be carried in one or two hands of a user while they are operating the portable apparatus 10. For example, the portable apparatus 10 may be a portable telephone, such as a mobile cellular telephone. In the following embodiment which is described in detail with reference to FIG. 1, the apparatus 10 is a mobile cellular telephone.

The controller 12 may be any suitable processor and is, in this embodiment, a microprocessor. The controller 12 is connected to read from and write to the memory 14. The memory 14 may be any suitable memory and may, for example be permanent built-in memory such as flash memory or it may be a removable memory such as a hard disk, secure digital (SD) card or a micro-drive.

The display 16 is coupled to the controller 12 for receiving and displaying data. The controller 12 may read data from the memory 14 and provide it to the display 16 for display to a user of the cellular telephone 10. The display 16 may be any suitable display and may be for example, a thin film transistor (TFT) display or a liquid crystal display (LCD).

The controller 12 is arranged to provide audio data to the audio output device 18. The audio output device 18 is arranged to convert the audio data into acoustic waves, audible to the user of the cellular telephone 10. The audio output device 18 may be, for example, a loudspeaker.

The audio input device 20 is arranged to convert acoustic waves (for example, a voice of a user) into an electrical signal for input to the controller 12. The audio input device 20 is in this embodiment a microphone.

The transceiver 22 is connected to the antenna arrangement 24 and to the controller 12. The controller 12 is arranged to provide data to the transceiver 22. The transceiver 22 is arranged to encode the data and provide it to the antenna arrangement 24 for transmission. The antenna arrangement 24 is arranged to transmit the encoded data as a radio signal.

The antenna arrangement 24 is also arranged to receive a radio signal. The antenna arrangement 24 then provides the received radio signal to the transceiver 22 which decodes the radio signal into data. The transceiver 22 then provides the data to the controller 12. In this embodiment, the radio signal has a frequency within a licensed cellular frequency band (for example, within a GSM frequency band (e.g. 900 MHz)).

The memory 14 stores computer program instructions 29, 31 that control the operation of the portable apparatus 10 when loaded into the controller 12. The computer program instructions 29 provide the logic and routines that enables the controller 12 to control the display 16 to display a three dimensional graphical user interface. The computer program instructions 31 provide the logic and routines that enables the controller 12 to change the mode of the first user input device 26.

The computer program instructions 31 provide means for changing between a first mode and a second mode, wherein when in the first mode, movement is enabled within the graphical user interface in a first dimension and a second dimension, orthogonal to the first dimension, and when in the second mode, movement is enabled within the graphical user interface in a third dimension, orthogonal to the first dimension and to the second dimension.

The computer program instructions may arrive at the portable apparatus 10 via an electromagnetic carrier signal 33 or be copied from a physical entity 35 such as a computer program product, a memory device or a record medium.

The first user input device 18 is operable by a user to provide control signals to the controller 12. The user can operate the first user input device 26 to control position and view in a graphical user interface, having three orthogonal dimensions, displayed on the display 16 (this will be discussed in greater detail in the following paragraphs). In one embodiment, the first user input device is a keypad of the cellular telephone. In another embodiment, the first user input device 26 is incorporated into the display 16 to provide a touch screen display 30. In a further embodiment, the first user input device 26 is incorporated into the audio input device 20 to provide voice recognition. In this embodiment, the user may control the position and view in a graphical user interface using his voice.

The second user input device 28 is operable by a user to change the mode of the first user input device 18. When the second user input device 28 receives an input from the user, it provides a control signal to the controller 12 to change the mode of the first user input device 18. When the mode of the first user input device 18 is changed, a given user input to the first user input device 26 provides one control in the graphical user interface in one mode, and a different control in the graphical user interface in another mode. For example, if a user operates the second user input device 28 to change the mode of the first user input device 26 to a first mode, movement in a first dimension and a second dimension (orthogonal to the first dimension) within the graphical user interface is enabled. If the user operates the second user input device 28 to change the mode of the first user input device 26 to a second mode, movement in a third dimension (orthogonal to the first dimension and orthogonal to the second dimension) within the graphical user interface is enabled. In combination with the second user input device 28, the first user input device 26 provides freedom of movement within a three dimensional graphical user interface to a user.

The second user input device 28 may be a separate input device or may be incorporated into the first user input device 26. The second user input device 28 may be any sensor for sensing a user input. For example, it may be one or more keys of a keypad of the cellular telephone. It may also be incorporated into a portion of the display 16 to provide a touch screen display or be one or more buttons provided on a surface of the cellular telephone.

How movement is performed within a three dimensional graphical user interface will be explained in the following paragraphs.

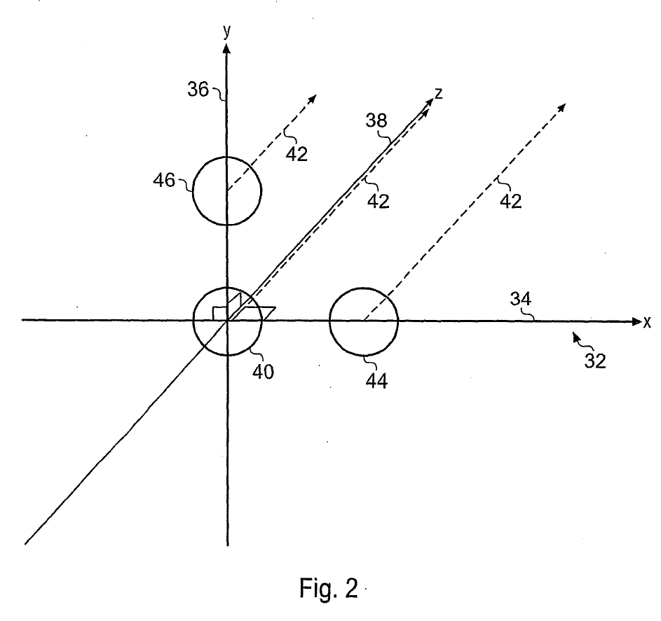

FIG. 2 illustrates a diagram showing horizontal and vertical panning within a three dimensional graphical user interface. A Cartesian co-ordinate system 32 is illustrated which provides three orthogonal axis X 34, Y 36 and Z 38. The X axis 34 and the Z axis 38 lie in the same plane as one another and are orthogonal to one another. The Y axis 38 extends perpendicularly from the plane defined by the X axis 34 and the Z axis 38. A circle 40 represents a starting position for the user in the graphical user interface and a dotted line 42 represents the orientation of the user's direction of view in the graphical user interface. As can be seen from FIG. 2, when the user is at a starting position in the graphical user interface they can be represented by the circle 40 which is centered at a point X=0, Y=0 and Z=0 and having a direction of view which is oriented parallel to the Z axis.

When the first user input device 26 is placed in a first mode by the second user input device 28, movement only in the direction of the X axis 34 and the Y axis 36 is enabled via the first user input device 26. Movement in the X axis 34 corresponds to horizontal panning within the graphical user interface and movement in the Y axis 36 corresponds to vertical panning within the graphical user interface. For example, if the user operates the first user input device 26 to move in the direction of the +X axis 34 within the graphical user interface, he will move from the position defined by the circle 40 to the position defined by the circle 44 (having co-ordinates X=n, Y=0, Z=0, where n is greater than zero). It should be noted that the orientation of the user's direction of view within the graphical user interface has not been altered and is still oriented parallel to the Z axis 38.

If the user operates the first user input device 26 to move in the direction of the +Y axis 36 within the graphical user interface, he will move from the position defined by the circle 40 to the position defined by the circle 46 (having co-ordinates X=0, Y=n, Z=0, where n is greater than zero). Once again, it should be noted that the orientation of the user's direction of view within the graphical user interface has not been altered and is still oriented parallel to the Z axis 38.

It should be appreciated that X and Y axis panning in the graphical user interface may be smooth (i.e. the user's position changes in small increments). Alternatively, X and Y axis panning in the graphical user interface may not be smooth and the user's position may change in relatively large increments.

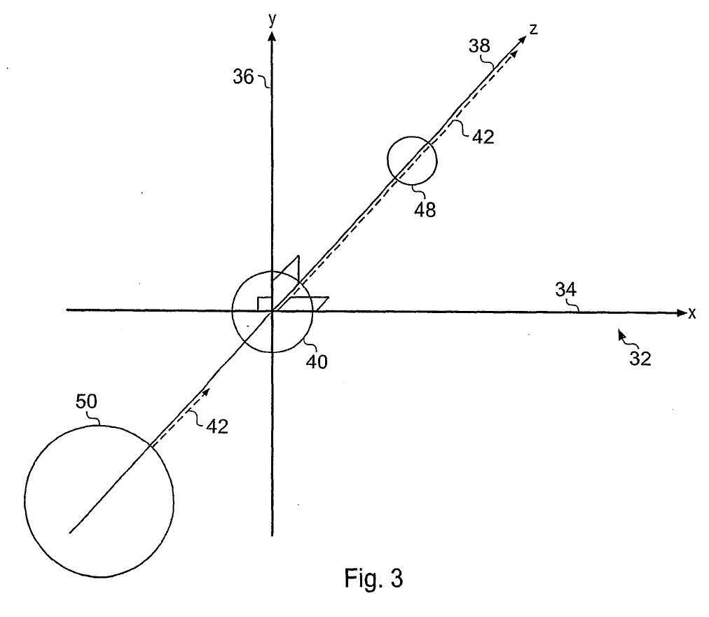

FIG. 3 illustrates a diagram showing dollying within a three dimensional graphical user interface. As in FIG. 2, a co-ordinate system 32 is provided and the user's starting position within the graphical user interface is represented by the circle 40 (centered at the position X=0, Y=0, Z=0). The orientation of the user's field of view within the graphical user interface is represented by the dotted line 42 (which is oriented parallel to the Z axis 38).

When the first user input device 26 is placed in a second mode by the second user input device 28, movement only in the direction of the Z axis 38 is enabled. Movement in the Z axis 38 corresponds to dollying within the graphical user interface (i.e. moving towards and away from an object in the graphical user interface). For example, if the user operates the first user input device 26 to move in the direction of the +Z axis 38 within the graphical user interface, he will move from the position defined by circle 40 to the position defined by the circle 48 (having co-ordinates X=0, Y=0, Z=n, where n is greater than zero). If the user operates the first user input device 26 to move in the direction of the −Z axis 38 within the graphical user interface, he will move from the position defined by circle 40 to the position defined by the circle 50 (having co-ordinates X=0, Y=0, Z=n, where n is less than zero). It should be noted that in both cases the orientation of the user's direction of view within the graphical user interface has not been altered and is still oriented parallel to the Z axis 38.

It should be appreciated that dollying in the graphical user interface may be smooth (i.e. the user's position changes in small increments). Alternatively, dollying in the graphical user interface may not be smooth and the user's position may change in relatively large increments.

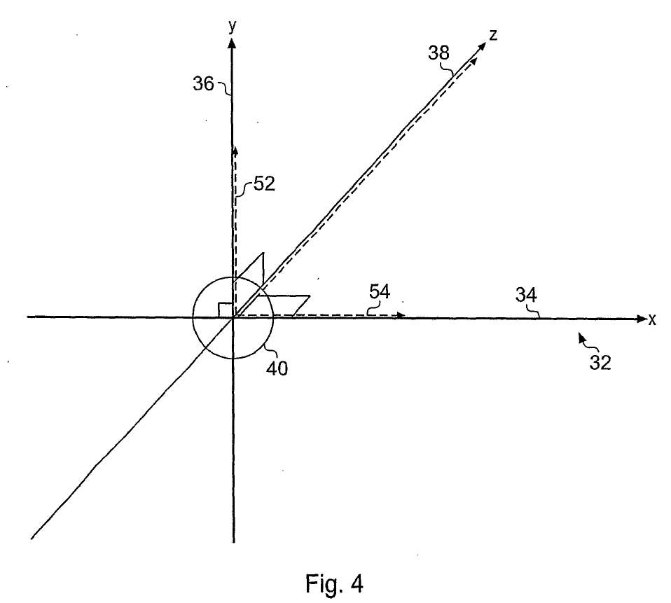

FIG. 4 illustrates a diagram showing rotation within a three dimensional graphical user interface. As in FIGS. 2 & 3, a co-ordinate system 32 is provided and the user's starting position within the graphical user interface is represented by the circle 40 (centered at the position X=0, Y=0, Z=0). The initial orientation of the user's field of view within the graphical user interface is represented by the dotted line 42 (which is oriented parallel to the Z axis 38). Rotation within a three dimensional graphical user interface results in a change in the orientation of the user's field of view but not a change in the user's position within the graphical user interface.

When the first user input device 26 is placed in a third mode by the second user input device 28, only rotation within the graphical user interface is enabled. For example, if the user operates the first user input device 26 to rotate the orientation of the user's field of view about the X axis 34 through ninety degrees, the user's field of view is changed and is represented by the dotted line 52 which is oriented parallel to the Y axis 36. If the user operates the first user input device 26 to rotate the orientation of the user's field of view about the Y axis 36 through ninety degrees, the user's field of view is changed and is represented by the dotted line 52 which is oriented parallel to the X axis 34.

It should be appreciated that rotation in the graphical user interface may be smooth (i.e. the user's field of view changes in small increments which may be less than one degree). Alternatively, rotation in the graphical user interface may not be smooth and the user's field of view may change in relatively large increments (ninety degree increments for example).

From the above, it can be seen that by changing the mode of the first user input device 26, the first user input device 26 is able to provide freedom of movement within a three dimensional graphical interface.

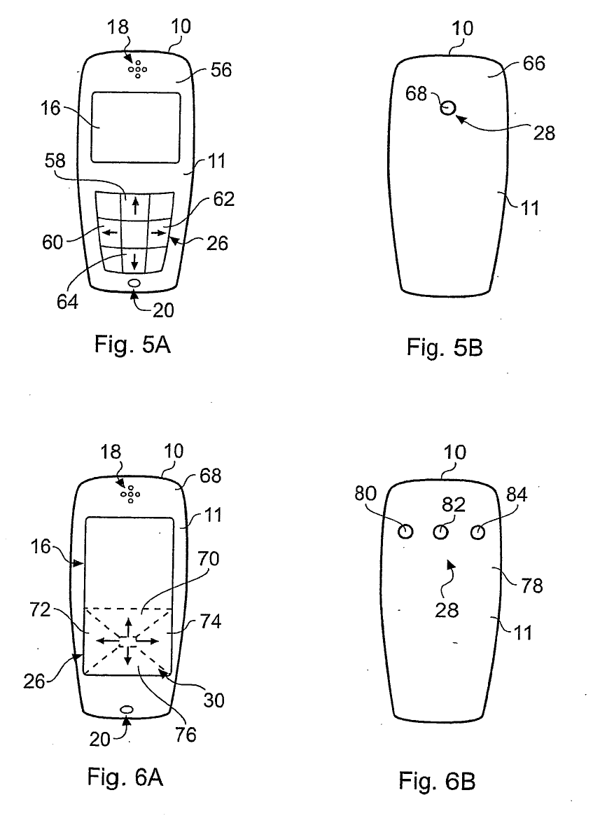

FIG. 5A illustrates a diagram of a front surface 56 of one embodiment of a portable apparatus 10. In this embodiment, the portable apparatus 10 is a mobile cellular telephone which includes a housing 11 which houses the electronic components illustrated in FIG. 1. In particular, the front surface 56 includes the display 16, the audio output device 18, the audio input device 20 and the first user input device 26. In this embodiment, the first user input device 26 is the keypad of the cellular telephone. Keys 58, 60, 62, 64, in combination with the second user input device, are operable by a user to control movement within a three dimensional graphical user interface displayed on the display 16. In another embodiment, the first user input device 26 includes a single key which rocks on two orthogonal axes to provide four inputs.

FIG. 5B illustrates a diagram of a rear surface 66 of the cellular telephone 10 illustrated in FIG. 5A. The rear surface 66 includes the second user input device 28 which in this embodiment has a single sensor 68. The sensor 68 is a button in this embodiment.

In use, when the first user input device 26 is in the first mode, the keys 58, 60, 62, 64 are operable to provide horizontal and vertical panning (as illustrated in FIG. 2) within the graphical user interface. Key 58 is operable by a user to move the user's position within the graphical user interface in the +Y direction (i.e. to position 46 illustrated in FIG. 2). Key 64 is operable by a user to move the user's position within the graphical user interface in the −Y direction. Key 62 is operable by a user to move the user's position within the graphical user interface in the +X direction (i.e. to position 44 illustrated in FIG. 2). Key 60 is operable by a user to move the user's position within the graphical user interface in the −X direction.

If the user provides an input to the button 68 of the second user input device 28, the mode of the first user input device 26 is changed to a second mode. In the second mode, the keys 58 and 64 are operable to provide dollying within the graphical user interface (as illustrated in FIG. 3). Consequently, key 58 is operable to move the user's position within the graphical user interface in the +Z direction (i.e. to position 48 illustrated in FIG. 3) and key 64 is operable to move the user's position within the graphical user interface in the −Z direction (i.e. to position 50 illustrated in FIG. 3). Keys 60, 62 are disabled by the controller 12 when the first user input device 26 is in the second mode.

In this embodiment, the first user input device 26 does not have a third mode and consequently, rotation of the user's field of view is not possible. If the user provides another input to the button 68, the mode of the first user input device 26 is changed back to the first mode.

In another embodiment, the user may press the button 68 to cycle through the first mode, the second mode and the third mode. In this embodiment, the second user input device 28 enables the user to perform horizontal and vertical panning, dollying and rotation.

FIG. 6A illustrates a diagram of a front surface 68 of another embodiment of a portable apparatus 10. In this embodiment, the portable apparatus 10 is a mobile cellular telephone which includes a housing which houses the electronic components illustrated in FIG. 1. In particular, the front surface 68 includes the display 16, the audio output device 18, the audio input device 20, and the first user input device 26. In this embodiment, the first user input device 26 is incorporated into the display 16 to provide a touch screen display 30. The touch screen display 30 is divided into four adjacent portions 70, 72, 74, 76 which are operable by a user to control movement within a three dimensional graphical user interface displayed on the display 16.

FIG. 6B illustrates a diagram of a rear surface 78 of the cellular telephone 10 illustrated in FIG. 6A. The rear surface 78 includes the second user input device 28 which in this embodiment has a first sensor 80, a second sensor 82, and a third sensor 84. In this embodiment, the sensors 80, 82 and 84 are buttons.

If the user provides an input to the first button 80 of the second user input device 28, the mode of the first user input device 26 is changed to a first mode. In the first mode, the portions 70, 72, 74, 76 of the touch screen display 30 are operable to provide horizontal and vertical panning (as illustrated in FIG. 2) within the graphical user interface. The portion 70 is operable by a user to move the user's position within the graphical user interface in the +Y direction (i.e. to position 46 illustrated in FIG. 2). The portion 76 is operable by a user to move the user's position within the graphical user interface in the −Y direction. The portion 74 is operable by a user to move the user's position within the graphical user interface in the +X direction (i.e. to position 44 illustrated in FIG. 2). The portion 72 is operable by a user to move the user's position within the graphical user interface in the −X direction.

If the user provides an input to the second button 82 of the second user input device 28, the mode of the first user input device 26 is changed to a second mode. In the second mode, the portions 70 and 76 are operable to provide dollying within the graphical user interface (as illustrated in FIG. 3). Consequently, portion 70 is operable to move the user's position within the graphical user interface in the +Z direction (i.e. to position 48 illustrated in FIG. 3) and portion 76 is operable to move the user's position within the graphical user interface in the −Z direction (i.e. to position 50 illustrated in FIG. 3). The portions 72 and 74 are disabled by the controller 12 when the first user input device 26 is in the second mode.

If the user provides an input to the third button 84 of the second user input device 28, the mode of the first user input device 26 is changed to a third mode. In the third mode, the portions 70, 72, 74 and 76 are operable to provide rotation within the graphical user interface (as illustrated in FIG. 4). Consequently, the portions 70 and 76 are operable to rotate the user's field of view about the X axis 34 (e.g. in FIG. 4, rotation from the dotted line 38 to the dotted line 52) and the portions 72 and 74 are operable to rotate the user's field of view about the Y axis 36 (e.g. in FIG. 4, rotation from the dotted line 38 to the dotted line 54).

In an alternative embodiment, the portions 70, 72, 74, 76 are defined by where the user initially provides an input to the touch screen display 30. In this embodiment, the position of the user's input on the touch screen display 30 defines the centre point about which the portions 70, 72, 74, 76 are located. For example, the user may provide an input to the touch screen display 30 in any location which will then define the centre point. The portions 70, 72, 74, 76 are then located about that centre point in the same way that they are illustrated in FIG. 6A.

Embodiments of the invention as described above with reference to FIGS. 5A, 5B, 6A and 6B provide an advantage in that they enable a user to control their movement within the graphical user interface with only one hand. The user may operate the second user input device 28 using his fingers on one hand and may operate the first user input device 26 using his thumb on the same hand. Consequently, embodiments of the present invention facilitate control of movement within a three dimensional graphical user interface on a portable apparatus.

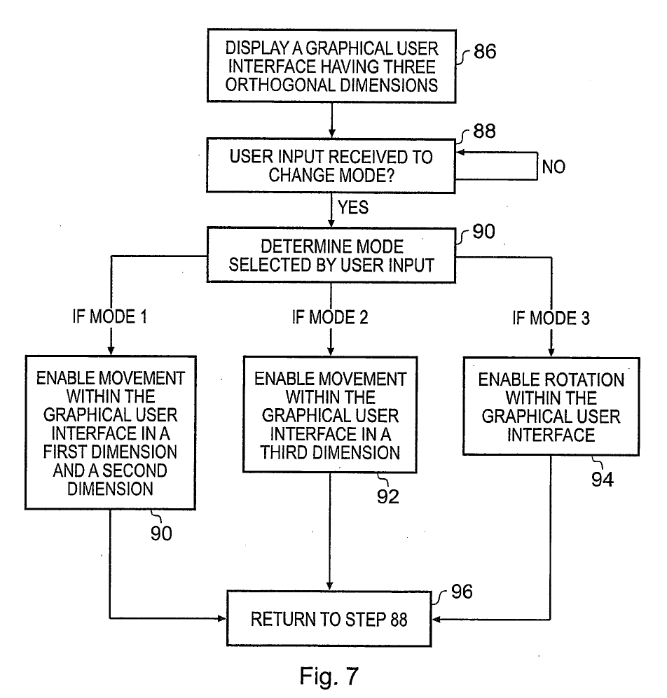

FIG. 7 illustrates a flow diagram of how the mode of the first user input device 26 is changed according to one embodiment of the present invention. Initially at step 86, the controller 12 controls the display 16 to display a graphical user interface which has three orthogonal dimensions. Then, at step 88 the controller 12 checks to see if it has received an input from the second user input device 28. If it has not received an input from the second user input device 28, the controller 12 repeats step 88 in a periodic manner. If the controller 12 has received an input from the second user input device 28, at step 90, the controller 12 then analyses the input and determines the mode of the first user input device 26 from the input.

If the controller 12 determines that the first user input device 26 should be placed in the first mode, at step 90 the controller 12 enables movement within the graphical user interface in a first dimension and a second dimension. If the controller 12 determines that the first user input device 26 should be placed in the second mode, at step 92 the controller 12 enables movement within the graphical user interface in a third dimension. If the controller 12 determines that the first user input device should be placed in the third mode, at step 94 the controller 12 enables rotation within the graphical user interface.

Once the first user input device 26 has been placed in a mode, the controller 12 returns to step 88 to check if an input has been received from the second user input device 28.

Although embodiments of the present invention have been described in the preceding paragraphs with reference to various examples, it should be appreciated that modifications to the examples given can be made without departing from the scope of the invention as claimed. For example, in other embodiments, the co-ordinate system 32 may be a cylindrical polar co-ordinate system or a spherical polar co-ordinate system. Consequently, it may be considered that when the first user input device 26 is in the first mode, movement on a surface is enabled. When the first user input device is in the second mode, the user may change the surface on which he is moving. For example, in a Cartesian co-ordinate system the surface is a plane, in a cylindrical co-ordinate system the surface is a cylinder and in a spherical co-ordinate system the surface is a sphere.

In other embodiments, the second user input device 28 may be incorporated into the display 16 to provide a touch screen display. For example, the sensors 80, 82, 84 (illustrated in FIG. 6B) may be incorporated into the display 16 to provide three touch screen portions which are operable by a user to change the mode of the first user input device 26.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
an integral display for displaying a graphical user interface having three orthogonal dimensions;
an integral first user input device, operable by a user to move within the graphical user interface in a first dimension and a second dimension, orthogonal to the first dimension, when the first user input device is in a first mode, and to move within the graphical user interface in a third dimension, orthogonal to the first dimension and to the second dimension, when the first user input device is in a second mode; and
an integral second user input device, operable by a user to change the mode of the first user input device between the first mode and the second mode.

2. An apparatus as claimed in claim 1, wherein the first user input device is provided on a front surface of the apparatus and the second user input device is provided on a rear surface of the apparatus.

3. An apparatus as claimed in claim 1, wherein the second user input device includes a first sensor for changing the mode of the first user input device to the first mode and a second sensor for changing the mode of the first user input device to the second mode.

4. An apparatus as claimed in claim 1, wherein the first user input device is operable by a user to rotate within the graphical user interface, when the first user input device is in a third mode.

5. An apparatus as claimed in claim 4, wherein the second user input device is operable by a user to change the mode of the first user input device between the first mode, the second mode and the third mode.

6. An apparatus as claimed in claim 5, wherein the second user input device includes a third sensor for changing the mode of the first user input device to the third mode.

7. An apparatus as claimed in claim 1, wherein moving within the first dimension corresponds to horizontal panning in the graphical user interface.

8. An apparatus as claimed in claim 1, wherein moving within the second dimension corresponds to vertical panning in the graphical user interface.

9. An apparatus as claimed in claim 1, wherein moving within the third dimension corresponds to dollying within the graphical user interface.

10. An apparatus as claimed in claim 1, wherein the first user input device includes a keypad of the apparatus.

11. An apparatus as claimed in claim 1, wherein first user input device is incorporated into the display to provide a touch screen display.

12. A method comprising:
displaying a graphical user interface having three orthogonal dimensions on an integral display of an apparatus;
changing between a first mode and a second mode of a first user input device, integral to the apparatus, using a second user input device, integral to the apparatus, wherein when in the first mode, movement is enabled within the graphical user interface in a first dimension and a second dimension, orthogonal to the first dimension, and when in the second mode, movement is enabled within the graphical user interface in a third dimension, orthogonal to the first dimension and to the second dimension.

13. A method as claimed in claim 12, comprising changing between the first mode, the second mode and a third mode of the first user input device, wherein when in the third mode, rotation is enabled in the graphical user interface.

14. A method as claimed in claim 12, comprising controlling the movement within the graphical user interface via the integral first user input device of the apparatus.

15. A method as claimed in claim 14, wherein the first user input device is provided on a front surface of the apparatus.

16. A method as claimed in claim 15, wherein the second user input device is provided on a rear surface of the apparatus.

17. A method as claimed in claim 12, wherein moving within the first dimension corresponds to horizontal panning in the graphical user interface.

18. A method as claimed in claim 12, wherein moving within the second dimension corresponds to vertical panning in the graphical user interface.

19. A method as claimed in claim 12, wherein moving within the third dimension corresponds to dollying within the graphical user interface.

20. A computer program comprising program instructions for causing a computer to perform the method of claim 12.

21. A computer program comprising program instructions for enabling movement within a graphical user interface, of an apparatus, having three orthogonal dimensions and comprising means for changing between a first mode and a second mode of a first user input device, integral to the apparatus, using a second user input device, integral to the apparatus, wherein when in the first mode, movement is enabled within the graphical user interface in a first dimension and a second dimension, orthogonal to the first dimension, and when in the second mode, movement is enabled within the graphical user interface in a third dimension, orthogonal to the first dimension and to the second dimension.

22. A physical entity embodying the computer program as claimed in claim 21.

23. An electromagnetic carrier signal carrying the computer program as claimed in claim 21.

24. A graphical user interface, for an apparatus, having three orthogonal dimensions and operable in a first mode and a second mode of a first user input device, integral to the apparatus, wherein when in the first mode, movement is enabled within the graphical user interface in a first dimension and a second dimension, orthogonal to the first dimension, and when in the second mode, movement is enabled within the graphical user interface in a third dimension, orthogonal to the first dimension and to the second dimension.

25. An apparatus comprising:
means, integral to the apparatus, for displaying a graphical user interface having three orthogonal dimensions;
means, integral to the apparatus, for providing movement within the graphical user interface in a first dimension and a second dimension, orthogonal to the first dimension, when the first user input device is in a first mode, and for providing movement within the graphical user interface in a third dimension, orthogonal to the first dimension and to the second dimension, when the first user input device is in a second mode; and
means, integral to the apparatus, for changing the mode of the first user input device between the first mode and the second mode
